(19) United States
(12) Patent Application Publication
(10) Pub. No.: US 2015/0062575 A1
(43) Pub. Date: Mar. 5, 2015

(54) METHOD FOR MEASURING PERFORMANCE OF A SPECTROSCOPY SYSTEM

(71) Applicant: RENISHAW PLC, Gloucestershire (GB)

(72) Inventors: Thomas Thurston, Shirehampton (GB); Ian Bell, Gloucestershire (GB); Brian Smith, Gloucestershire (GB); Andrew Woolfrey, Gloucestershire (GB); Julie Green, South Lanarkshire (GB)

(21) Appl. No.: 14/389,786

(22) PCT Filed: Apr. 2, 2013
(86) PCT No.: PCT/GB2013/050864

§ 371 Date: Oct. 1, 2014

(30) Foreign Application Priority Data
Apr. 5, 2012 (GB) 12163397.8

(51) Int. Cl. G01M 11/00; G01J 3/44

(52) U.S. Cl. CPC G01M 11/00; G01J 3/44
USPC 356/301; 29/407.01

(57) ABSTRACT

A method of measuring the performance of a spectroscopy system including obtaining a plurality of component spectra for each component of a set of components that are to be identified by the system, the component spectra obtained for variations of at least one factor that affects the component spectrum. Sample spectra and then simulated, each sample spectrum simulated for a corresponding potential sample using at least one different component spectrum and/or a different amount of at least one of the component spectra to that used to simulate the other sample spectra. The sample spectra are analysed to obtain, for each sample spectrum, a measured quantity and/or quality for a characteristic of the corresponding potential sample and a measure of performance generated based upon the measured quantities and/or qualities. The invention also concerns apparatus for carrying out this method.

### FIELD OF INVENTION

This invention concerns a method for measuring performance of a spectroscopy system. The invention has particular, but not exclusive, application to measuring the performance of a Raman spectroscopy system used to identify or quantify one or more components present in a sample from a known set of possible components, such as in a multiplex assay.

### BACKGROUND

It is known to use Raman spectroscopy to identify components present in a sample. To enhance the Raman signal, surface enhanced resonance Raman scattering (SERRS) may be used. SERRS uses the principle that the molecules of the component to be identified are adsorbed on an active surface containing a chromophore having an electronic transition with a frequency near to (preferably within 150 nm) of the laser wavelength used to excite the plasmon on the enhancing substrate.

For a biological sample, to provide a sufficiently distinct chromophore for each type of molecule to be identified, the sample may be treated to attach different dyes to each type of molecule to be identified (e.g. different types of oligonucleotides). Examples of such techniques are described in WO09/022125 and US2006246460, which are incorporated herein by reference.

In one form, an assay is constructed to detect disease states by attaching the dye to an oligonucleotide built to complement a target nucleotide sequence (target sequence) known to be unique to the causative organism(s). It is then introduced to a sample containing DNA fragments. If the target sequence(s) are present in the sample the dye labelled oligonucleotide hybridises to it. By adding an oligonucleotide with biotin which also recognises the target sequence it is possible to separate the DNA complex containing the target sequence and the dye using streptavidin coated magnetic beads which attach to the complex via the biotin/streptavidin interaction. The dye sequence is then released and adsorbed onto silver or gold nanoparticles which, preferably when aggregated, act as the SERRS substrate for the dye giving very strong signals from an aqueous environment. It is a characteristic of SERRS that the spectrum consists of a sharp set of lines almost always exclusively from the dye. This is because the Raman scattering surface enhancement factor for the dye is very high compared to the enhancement factor from the rest of the oligonucleotide so other signals are very weak in comparison. These sharp lines are characteristic of the dye giving in situ identification and the sharp nature of the lines mean that mixtures of dyes can be identified without separation. This enables the detection of multiple labels in one sample.

It is desirable to measure a level of performance that can be expected from such a multiplex assay. However, the complexity of the multiplex assay and the unknown nature of a sample mean that there is a wide range of factors that could affect the chances of correctly identifying or quantifying an analyte in the sample. It is desirable that a measure of performance of the multiplex assay takes into account this wide range of factors in order that the measure of performance fairly reflects the performance that is likely to be achieved by the user.

One way in which a performance of a system can be measured is to carry out multiple experiments in which factors that can change are deliberately varied and, from the results, a determination is made of the performance of the system. However, if the number of factors that can vary is large, if the factors are difficult to control or if one or more of the factors can vary over a large range, conducting experiments even approximately spanning all possible circumstances that can occur to obtain a representative measure of performance is a considerable challenge, if indeed it is possible at all.

### SUMMARY OF INVENTION

According to a first aspect of the invention there is provided a method of measuring the performance of a spectroscopy system comprising
a) obtaining a plurality of component spectra for each component of a set of components that are to be identified by the system, the component spectra obtained for variations of at least one factor that affects the component spectrum,
b) simulating sample spectra, each sample spectrum simulated for a corresponding potential sample using at least one different component spectrum and/or a different amount of at least one of the component spectra to that used to simulate the other sample spectra;
c) analysing the sample spectra to obtain, for each sample spectrum, a measured quantity and/or quality of a characteristic of the corresponding potential sample, and
d) generating a measure of performance based upon the measured quantities or qualities.

In this way, a measure of performance can be determined within a reasonable time frame that takes into account possible variation that may occur. In particular, it may be possible to collect a plurality of component spectra for each single component identifiable using the system that is representative of the spectral variability that may occur. These single spectra can then be used to simulate scenarios for which spectra have not been obtained, for example, variations in performance that occur with different concentrations and/or components and the performance of the system when more than one of the components is present in a sample. This approach may assume that the spectral response from a single component is linear with concentration and additive in the presence of spectral contributions from other components; that is the Beer-Lambert law is obeyed by the system.

Many sample spectra may be simulated for any one potential sample in order to obtain a statistically significant measure of performance for that potential sample.

Accordingly, there may be a many-to-one correspondence between the sample spectra and potential sample(s). However, it may not be necessary to simulate multiple sample spectra for any one potential sample, such as if the measure of performance is for the overall system rather than specific to a particular potential sample.

The analyses may comprise qualifying the presence and/or absence of components based upon the sample spectrum. In such an embodiment, sample spectra may be simulated for different relative concentrations of the components but the analysis may only be concerned with whether or not a component can be identified. However, the analyses may comprise quantifying a concentration of components from the sample spectrum.

The measure of performance may comprise a measure of sensitivity and/or specificity of the system in identifying and/or quantifying one or more of the components. The measure of performance may comprise a limit of concentration of one or more of the components in a sample at which a minimum level of sensitivity is achieved for identifying and/or quantifying the one or more components.

Each sample spectrum may be simulated for a specified quantity and/or quality of the characteristic of the corresponding potential sample and generating a measure of performance comprises a comparison of the measured quantity and/or quality with the specified quantity and/or quality. For example, a sample spectrum may be simulated for a specified component and/or concentration of the component in the potential sample and the analyses step identifies components and/or concentrations of components from the sample spectrum, the component and/or concentration identified in the analyses step compared to the specified component and/or concentration to determine a measure of performance. Alternatively or additionally, the analyses step obtains measurement of a quality and/or quantity that was not specified/known in advance of simulating the sample spectrum, such as distance between characteristic peaks.

The plurality of component spectra for each component may be obtained by performing experiments in accordance with an experimental design, such as fractional or full factorial design, in which factors identified as influencing a spectral response of the components are varied through a range of possibilities. These factors may include operator, time between preparation of a sample and measurement, instrument from which spectra are obtained, batch of the component(s) and/or batch of reagents, such as dye and/or colloid. The range in which factors may vary may be limited by system specifications, for example the system specification may require that the spectrum of a sample is obtained with a particular type, such as make, of instrument such that it is not necessary to obtain spectra from other makes of instruments and/or may require that the batch of components are obtained from a particular source such that it is not necessary to obtain spectra for components obtained from other sources.

The plurality of component spectra obtained for each component may be obtained with the component at the same concentration, which may be a pre-determined reference concentration. However, these concentrations may vary between components, depending upon system specifications.

The analyses may comprise analysing each sample using a reference spectrum for each component to obtain the measured quantity and/or quality of the characteristic. The method may comprise selecting a reference spectrum for each component of the set of components, each reference spectrum selected from the plurality of component spectra for that component and differing from the component spectrum used to simulate the sample spectrum that is analysed using the reference spectrum. Different reference spectra may be selected for the analysis of different sample spectra. In this way, the measure of performance may take account of variations in reference spectra as well as variations in sample spectra. Use of different reference spectra to analyse a sample spectrum may produce different results. A pool of component spectra from which a reference spectrum may be selected may be limited by system requirements. For example, if it is a requirement when analysing an unknown sample that the reference spectra are obtained using the same spectroscopy apparatus as that used to obtain the spectrum from the unknown sample, the method of measuring performance may only select reference spectra from component spectra that have been collected using the same apparatus as the component spectrum/spectra used to simulate the sample spectrum. Similar restrictions on the reference spectra may apply to other factors such as temperature, time between measurements, etc whose variation may be limited between reference spectra and sample spectra, even though the plurality of component spectra capture a greater range of variations.

The sample spectra may be simulated for different concentrations of the or each component in the potential sample.

The component spectra used to simulate each sample spectrum, and optionally the reference spectra used to analyse each simulated sample spectrum, may be randomly selected from an appropriate set of spectra. Such a procedure may be appropriate when the number of possible combinations of component spectra and reference spectra is so large as to make a more systematic approach unfeasible. An appropriate set of component spectra may be all of the component spectra for a component or may be a subset of these component spectra.

The or each component in the potential sample and/or a concentration of the the or each component in the potential sample may be randomly selected based upon at least one probability distribution. Such a probability distribution may represent the likelihood of finding a component, combination of components and/or concentration of a component in a sample. The probability distribution may be a likelihood of a sample containing particular components, a particular component at various concentrations or combinations of particular components. Alternatively, a probability distribution may not be specific to particular components but may be a general likelihood of a sample containing a non-specific component of the set at various concentrations or a number of non-specific components in a combination. This alternative may be appropriate when the probability distributions are similar for different components/combinations such that there is little advantage in using separate distributions for different components/combinations or when there is insufficient information for component specific probability distributions. Biasing the random selection towards certain combinations using the probability distribution may ensure that the measure of performance is not biased by scenarios that are unlikely to occur in reality.

The analysis may be a multivariate analysis technique, such as a method based upon a direct classical least squares (DCLS) analysis.

The method may be for measuring the performance of a system using surface enhanced resonance Raman spectroscopy (SERRS), such as a SERRS multiplex assay, as described above. The components may be dyes to be used within the multiplex assay.

The method may form part of a method of selecting specifications of the system. Specifications of the system may be selected and/or modified based upon the measurements of performance. Such selection and/or modification of the specifications may alter the set of component spectra and/or potential samples that can be measured by the system. For example, in response to measurement of performance of an initial set of sample spectra, more stringent requirements may be placed on a factor that influences spectral response of the components, eg modifying the maximum time allowed between preparation of a sample and measurement, eliminating the need to simulate sample spectra using component spectra obtained under conditions falling outside of these new specifications and/or only for a subset of components.

Initially, the performance may be measured for potential samples comprising only one component, with an initial selection and/or modification of the specifications being made based upon these measurements, later measurements of performance based upon potential samples comprising multiple components. In this way, spectra and/or components may be eliminated before analysing multi-component samples reducing the number of possible multi-component samples, and therefore, the processing that is required.

The invention also concerns a system, such as a multiplex assay, designed in accordance with the above method.

According to another aspect of the invention there is provided data carrier having instructions thereon which, when executed by a processor, cause the processor to:
a) retrieve a plurality of component spectra for each component of a set of components that are to be identified by a spectroscopy system, the component spectra obtained for variations of at least one factor that affects the component spectrum,
b) simulate sample spectra, each sample spectrum simulated for a corresponding potential sample using at least one different component spectrum and/or a different amount of at least one of the component spectra to that used to simulate the other sample spectra;
c) analyse the sample spectra to obtain, for each sample spectrum, a measured quantity and/or quality of a characteristic of the corresponding potential sample, and
d) generate a measure of performance based upon the measured quantities and/or qualities.

According to a further aspect of the invention there is provided apparatus for measuring the performance of a spectroscopy system, the apparatus comprising:—
a processor arranged to:
a) retrieve a plurality of component spectra for each component of a set of components that are to be identified by a spectroscopy system, the component spectra obtained for variations of at least one factor that affects the component spectrum,
b) simulate sample spectra, each sample spectrum simulated for a corresponding potential sample using at least one different component spectrum and/or a different amount of at least one of the component spectra to that used to simulate the other sample spectra;
c) analyse the sample spectra to obtain, for each sample spectrum, a measured quantity and/or quality of a characteristic of the corresponding potential sample, and
d) generate a measure of performance based upon the measured quantities and/or qualities

The apparatus may comprise memory having stored thereon a library of the plurality of component spectra, the processor arranged to retrieve the spectra form the memory, as required. It will be understood that the step of retrieving a plurality of spectra from memory may be carried out before or during step b). For example, the relevant spectrum may be retrieved only once it has been selected for use as a reference spectrum or for simulating the sample spectrum.

According to a further aspect of the invention there is provided a method of designing a multiplex assay that uses spectroscopy to identify analytes comprising selecting a specification for the multiplex assay, simulating spectra representative of possible variation of factors within the specification, calculating a measure of performance based upon the simulated spectra and modifying the specification based upon the measure of performance.

According to another aspect of the invention there is provided a method of measuring the performance of a spectroscopy system comprising
a) obtaining a plurality of component spectra for each component of a set of components that are to be identified by the system, the component spectra obtained for variations of at least one factor that affects the component spectrum,
b) simulating a sample spectrum for a potential sample using the component spectra;
c) analysing the sample spectrum multiple times using different sets of reference spectra selected from the plurality of component spectra to obtain a measured quantity and/or quality of a characteristic of the potential sample with each set of reference spectra, and
d) generating a measure of performance based upon the measured quantities and/or qualities.

### DESCRIPTION OF THE DRAWINGS

FIG. 1 is a diagram showing steps in a method of determining a measure of performance in accordance with one embodiment of the invention;

FIG. 2 is a diagram illustrating the simulation of a sample spectrum in accordance with one embodiment of the invention;

FIG. 3 is a table showing a measure of performance in accordance with one embodiment of the invention;

FIG. 4 is a table showing another a measure of performance in accordance with another embodiment of the invention;

FIG. 5 is a table showing a measure of performance in accordance with a further embodiment of the invention;

FIG. 6 is a schematic graphical representation of the measures of performance shown in FIGS. 3 and 4; and

FIG. 7 is a flowchart illustrating a method of analysing a spectroscopy spectrum.

### DESCRIPTION OF EMBODIMENTS

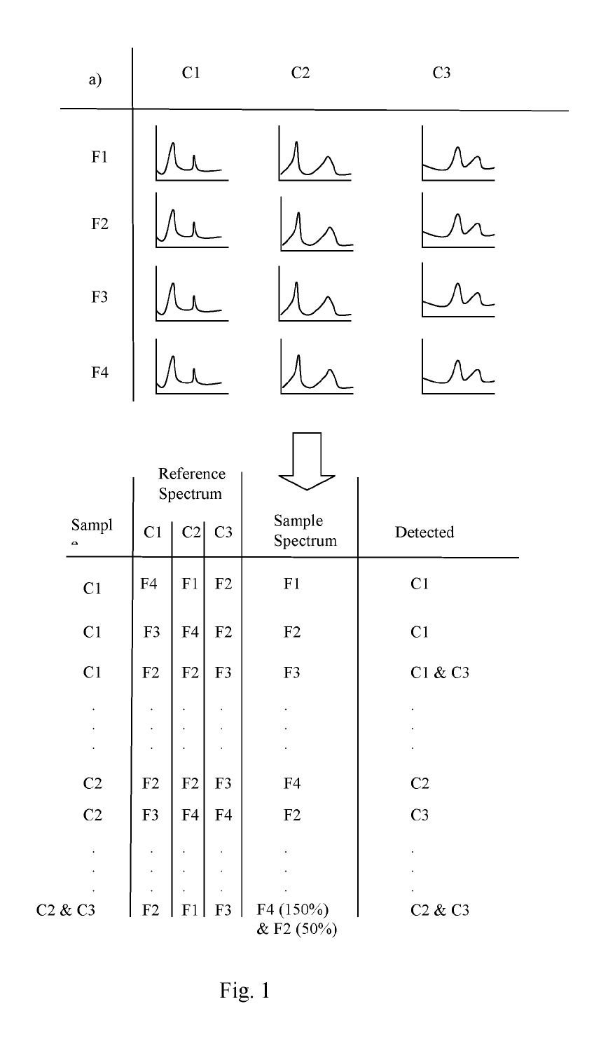

Referring to FIG. 1, a first step in a method of measuring the performance of a spectroscopy system comprises obtaining spectra for each component that contributes to the spectrum measured by the system, the spectra representative of signal variability for the component. In order to achieve a representative set of spectra, spectra are obtained under different conditions using a fractional factorial experimental design. Such an experimental design will cover a number of factors that may affect the signal from the component, such as operator, time between preparation of a sample and measurement, instrument from which spectra are obtained, batch of the component(s) and/or batch of reagents, such as dye and/or colloid in the case of SERRS. The range over which experimental data is obtained may depend on specifications defined for the spectroscopy system. For example, in the case of a multiplex assay used for medical diagnosis, a maximum time may be specified between adding colloid to a sample from a patient and measurement, the fractional factorial experimental design specifying obtaining spectra from samples wherein the time between adding the colloid and measurement of a sample varies across a range of values below the maximum time.

In this embodiment, each spectrum is obtained from a test sample containing the component at a reference concentration. The reference concentration may be selected to be a target or expected concentration of the component in an unknown sample to be analysed. For example, an expected concentration of an analyte in a patient sample or a target concentration to be achieved by an amplification of the analyte, such as by PCR.

There is no lower or upper limit on the number of spectra, but each set should encompass factors effecting variation in the spectroscopy signal. In this embodiment, the spectra are filtered to remove spectra where the spectroscopy signal is either significantly weaker of stronger than the average. This is intended to remove outlying spectra, which are not representative of the variation to be expected.

FIG. 1 schematically represents a plurality of spectra obtained for each component C1, C2 and C3 for a range of different conditions F1 to F4. These spectra may be stored in memory to form a library of spectra for future processing.

A set of “blank” spectra (not shown) are also obtained for samples containing no components of interest. For example, a spectrum may be obtained from a sample comprising the support substrate only.

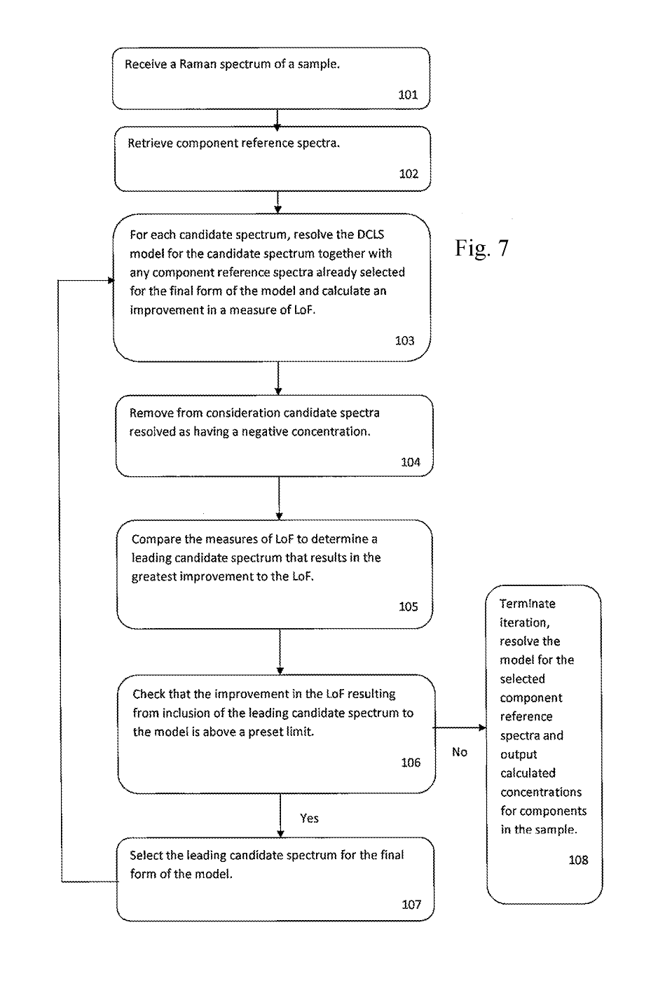

In a second step, an analysis technique is used to determine whether the correct component(s) can be identified from a simulated spectrum for a plurality of potential samples. In this embodiment, the analysis technique is a method based upon Direct Classical Least Squares (DCLS) fitting of reference spectra to a sample spectrum, as described below with reference to FIG. 7.

To obtain a statistically significant data set, sample spectra are repeatedly simulated and analysed for a potential sample by:—
i) for each component, randomly selecting a reference spectrum from the plurality of spectra for that component,
ii) randomly selecting a spectrum/spectra for the or each component that is designated as present in the potential sample and simulating a sample spectrum for a potential sample using the selected spectra/spectrum, and
iii) analysing the sample spectrum using the algorithm described below with reference to FIG. 7 and the reference spectra to identify one or more components.

These steps are carried out for a number of different potential samples. The table of FIG. 1 schematically shows these steps, each row of the table showing, from left to right, the component(s) that make up the sample, the spectra selected for use as reference spectra, the spectra used to simulate the sample spectrum and the components that were detected through analysis of the sample spectrum using the reference spectra.

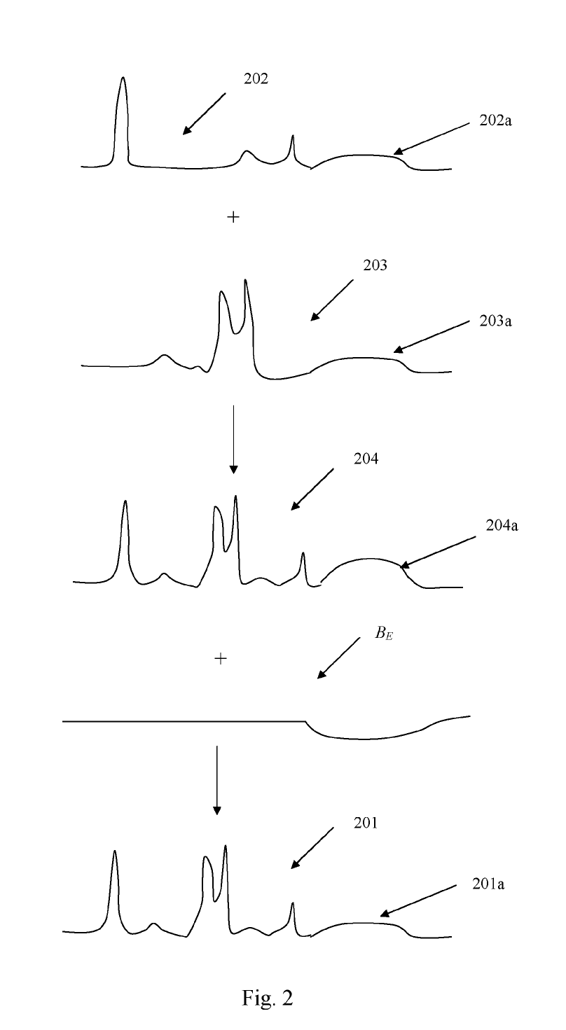

Referring to FIG. 2, in this embodiment, to simulate a sample spectrum 201 in step ii) for a potential sample comprising multiple components it is necessary to combine the component spectra 202, 203 selected for the components. This may be achieved by adding the spectra 202, 203 together, possibly scaled to simulate a sample in which the components are at a concentration that is higher or lower than their reference concentration. However, each component spectrum 202, 203 comprises a contribution 202a, 203a from the substrate on which the test sample was held (so called “blank contribution”). The addition of multiple component spectra together may result in a combined spectrum 204 wherein the blank contribution 204a is more or less than that which would typically occur from the blank. For example, in the case of two components, if both component spectra are added at over 50% of their reference concentration, a blank contribution from each component spectra will add to over 100% of a typical blank contribution. Accordingly, to obtain a representative sample spectrum a blank contribution may need to be removed or added from the combined component spectra. This is achieved by randomly selecting a blank spectrum from the set of blank spectra and adding a blank contribution, B_{E}, determined in accordance with:

$${\underline{B}}_{E} = \{ 1 - {Σ}_{k} {C}_{k} \} \underline{B}$$

wherein Cₖ is the concentration relative to its reference concentration for each component k in the potential sample and B is the selected blank spectrum. In this way, the resultant sample spectrum 201 comprises a blank contribution 201a that is representative of that which would be found in a signal from a typical sample.

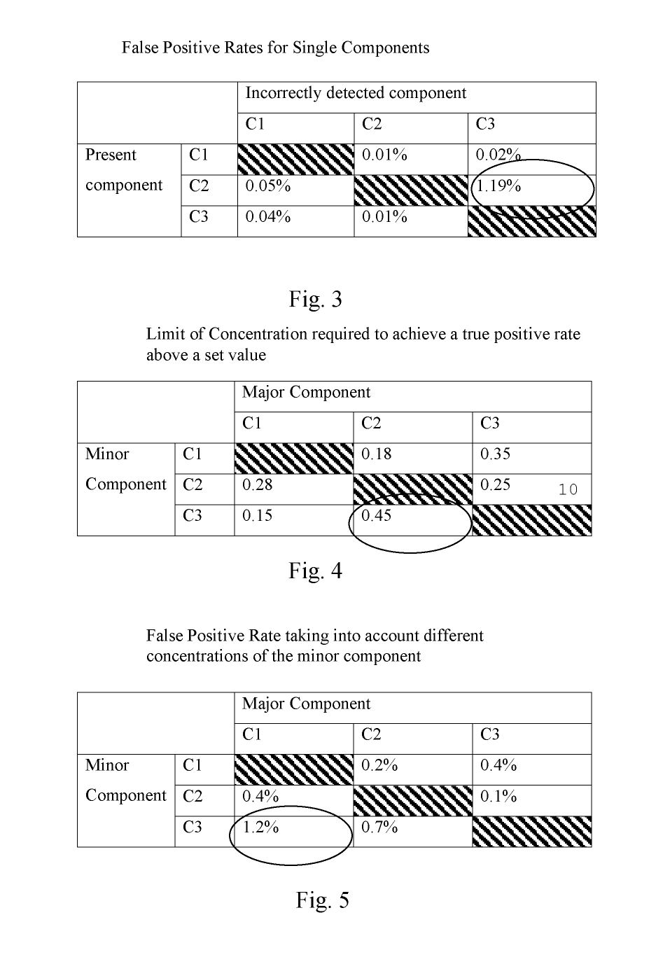

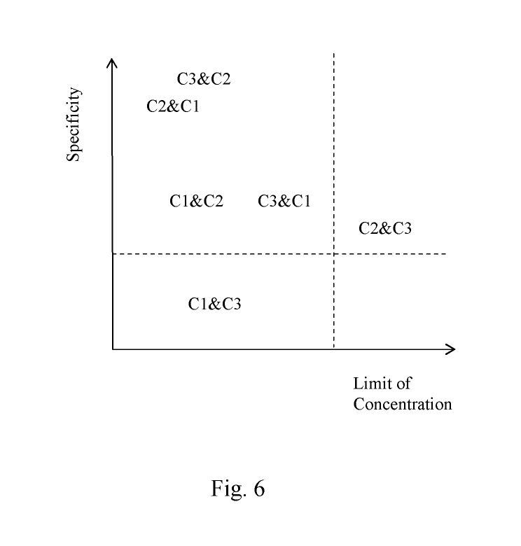

In a third step one or more measures of performance are calculated from the data set. Referring to FIG. 3, in one embodiment, the measure of performance is an estimated percentage of false positives (specificity) for each component (ie a number of times a component is incorrectly identified as present for a specified sample). In FIG. 3, false positives have been determined just for potential samples comprising only one component. Although false positives can be calculated for samples comprising multiple components, this is complicated by changes in the detection rate of components that may occur with changes in the relative concentrations of components within the samples, as described in more detail with reference to FIG. 5.

Alternatively or additionally, the measure of performance may be an estimated number of true positives (sensitivity) for each specified sample.

FIG. 4 illustrates a measure of performance that may be determined for samples comprising multiple components. For this measure, data is simulated for samples, wherein a ratio of a major component relative to its reference concentration and a minor component relative to its reference concentration is varied and a limit of concentration of the minor component is determined at which the number of true positives (sensitivity) is above a predefined level. A lower limit of concentration indicates that the component is detectable over a larger range of concentrations when in the presence of one or more other components. Such a measure of performance may be useful in designing a system, such as a multiplex assay, in that it may help to define a window of concentrations in which an analyte can be identified with a defined confidence level.

FIG. 5 illustrates a measure of performance based upon estimated false positive rates for samples comprising multiple components. Such a measure differs from that shown in FIG. 4, in that the false positives are associated with each combination of major and minor component. The false positive rate should be determined for a range of concentrations of the minor (and possibly major) component as, unlike true positives where the rate will typically fall off as the concentration of the minor component is reduced, a rate of false positives may not vary linearly with concentrations of the minor (or major) component.

The measure(s) of performance may be used to select/modify specifications for a system. For example, a component may be selected for use in a multiplex assay based upon whether or not its sensitivity, limit of concentration and/or specificity is above a predefined level. FIG. 6 illustrates how such a decision may be made. In FIG. 6, the dotted lines represent cut-off points within which a performance of a sample is considered acceptable with respect to specificity and limit of concentration. As can be seen from the graph, in this illustration one sample comprising components C1 and C3 and another sample comprising components C2 and C3 have unacceptable levels of performance. This is also illustrated by the circled figures in FIGS. 4 and 5. By removing component C3 from the possible list of components, the unacceptable samples are eliminated. This may also eliminate a relatively high false positive rate for component C3 in a sample consisting of component C2.

Other measurements of performance may be used for selecting/modifying other specifications of the system. For example, measures of performance may be determined for different time periods between adding a colloid to a sample and taking a measurement. A cut-off point could then be determined at which a delay between adding the colloid and taking a measurement reduces sensitivity, specificity, a limit of concentration or other statistical measure of performance below an acceptable level. Such analysis may be carried out for other factors that may affect the spectroscopy signal, such as source of components/reagents, relative concentration of reagents and/or type of spectroscopy apparatus on which spectra are collected.

In a further embodiment, the sample spectra that are simulated may be based upon probability distributions used to select the components and concentrations for the components. To simulate a sample spectrum, firstly a random selection is made on whether or not each component of the set is present based upon a probability distribution. A simple form of such a selection comprises using data on probabilities that one, two, three, etc components are present in a sample to randomly select how many components are present and then randomly selecting, based on an equal probability for each component, that number of components from the set of components. Secondly, a random selection is made of the concentration of each component in the sample relative to its reference concentration. Again, a simple form of such a selection is to use a single probability distribution for concentration of a component to randomly select the concentrations of all the components that have been selected as present. A sample spectrum is then simulated using a randomly selected spectrum for each component selected as present scaled for the chosen concentration.

Such a simple form for randomly selecting the component spectra and concentration used to simulate the sample spectrum may be used because of lack of information on probabilities for individual components or because the likelihood of a component being present in a sample and/or likelihood of a component having a particular concentration relative to its reference concentration is the same or similar for all the components of the set and for all combinations of components. Where there is a significant variation between components, individual probability data may be used for each component. Such data may comprise data on the likelihood of each component being found on its own as well as the likelihood of the component being found in the presence of other components. For example, one component may be used as a control in a multiplex assay and therefore, have a very high chance of being present, or two components may have a zero or very low chance of being found together if they are naturally mutually exclusive. Different probability distributions for concentrations of the components may also be used.

The use of probability distributions for biasing selections could also be extended to the selection of a component spectrum for a particular component. For example, a random selection of a component spectrum may be made based upon a probability distribution for variation in a particular factor for which component spectra were collected, such as the time between adding a colloid to the sample and measurement where it may more likely that the time between falls at a central time between two extremes. Selection of the component spectrum may be biased towards selecting a component spectrum obtained for a more likely value of the factor.

Such a method of forming sample spectra may provide a set of sample spectra that are more representative of that which would have been obtained through experiment/in use. A measurement of performance calculated from the set may be more representative of that to be expected because it is not unduly distorted by over-representation of sample spectra determined for improbable potential samples.

The invention has particular application to measuring the performance of a multiplex assay in which SERRS is used to identify the components. However, the method of the invention could be used to measure the performance of other spectroscopy systems and, in particular, other Raman based systems, in which a reference spectrum is used to identify an unknown component from that unknown component's spectrum.

Referring to FIG. 7, the Direct Classical Least Squares technique for analysing the simulated spectra models the simulated spectral data X in terms of a set of K known component reference spectra Sₖ each having I data points. Component concentrations, Cₖ, for each component reference spectrum are determined by minimising the sum of the squared deviations of the spectral data from the reconstructed model,

$${{Σ}_{i}^{I} [ {X}_{i} - {Σ}_{k}^{K} {C}_{k} {S}_{ki} ]}^{2} \qquad ( 1 )$$

where i represents the spectral frequency index. This results in a series of linear equations which can be solved directly by matrix inversion for the component concentrations Cₖ.

An iterative process is carried out in which Equation (1) is resolved for each candidate component using the selected reference spectrum, steps 103 to 108.

In step 103, for each candidate component, equation (1) is minimised for the component's reference spectrum together with any component reference spectra that have already been selected in a previous iteration. A measure of goodness of fit is calculated for the resolved components relative to the simulated spectrum.

The measure of goodness of fit can be a measure of lack of fit (LoF) given by:—

$$LoF = \sqrt{\frac{{{Σ}_{i = 1}^{I} [ {x}_{i} - {Σ}_{k = 1}^{K} {c}_{k} {s}_{ki} ]}^{2}}{{Σ}_{i = 1}^{I} {x}_{i}^{2}}} \qquad ( 2 )$$

This measure of lack of fit is compared to a previous measure of LoF calculated for the selected component reference spectra before the addition of the candidate component reference spectrum to determine an improvement to the measure of LoF resulting from the addition.

The improvement in the LoF, L_{Ipr}, is calculated as a proportional improvement in the LoF:—

$${L}_{Ipr} = \frac{{L}_{old} - {L}_{new}}{{L}_{old}} \qquad ( 3 )$$

where L_{old} is the LoF value calculated for the selected component reference spectra before the inclusion of the candidate component reference spectrum and L_{new} is the LoF value calculated for the selected component reference spectra including the candidate component reference spectrum.

In step 104, the candidate component reference spectra resolved as having a negative concentration are removed from further consideration in the iteration (but not subsequent iterations).

In step 105, the improvements in the LoF, L_{Ipr}, for the remaining candidate component reference spectra are compared and the candidate component reference spectrum associated with the greatest improvement in the LoF becomes the leading candidate component reference spectrum for inclusion in the final form of the model.

A check 106 is made to determine whether the improvement in the LoF resulting from addition of the leading candidate component reference spectrum is above a preset limit. If the improvement to the LoF, L_{Ipr}, for the leading candidate component reference spectrum is above the preset limit, it is selected 107 as a component reference spectrum that is present in the final form of the model. The process 103 to 107 is then repeated for the remaining unselected component reference spectra.

If the improvement to the LoF, L_{Ipr}, for the leading component reference spectrum is below the preset limit, then the method is terminated and the final form of the model, comprising the model resolved for the component reference spectra selected up to that point, is output. The final form of the model will typically comprise a subset of the set of predetermined component reference spectra, these spectra being those of most significance as measured by lack of fit.

A determination can be made of components present in the sample based upon whether the reference spectrum corresponding to a component is included in the final form of the model.

Further details regarding the above method and of the preferred apparatus for conducting this method can be found in UK patent “Spectroscopic apparatus and methods for determining components present in a sample” application number EP11250530.0, filed on 16 May 2011.

1. A method of measuring the performance of a spectroscopy system comprising
a) obtaining a plurality of component spectra for each component of a set of components that are to be identified by the system, the component spectra obtained for variations of at least one factor that affects the component spectrum,
b) simulating sample spectra, each sample spectrum simulated for a corresponding potential sample using at least one different component spectrum and/or a different amount of at least one of the component spectra to that used to simulate the other sample spectra;
c) analysing the sample spectra to obtain, for each sample spectrum, a measured quantity and/or quality for a characteristic of the corresponding potential sample, and
d) generating a measure of performance based upon the measured quantities and/or qualities.

2. A method according to claim 1, wherein the analyses comprises qualifying the presence and/or absence of components.

3. A method according to claim 1, wherein the measure of performance comprises a measure of sensitivity and/or specificity of the system in identifying and/or quantifying one or more of the components in a sample and/or a limit of concentration of one or more of the components in a sample at which a minimum level of sensitivity is achieved for identifying and/or quantifying the component.

4. A method according to claim 1, wherein each sample spectrum is simulated for a specified quantity and/or quality of the characteristic of the corresponding potential sample and generating a measure of performance comprises a comparison of the measured quantity and/or quality with the specified quantity or quality for each sample spectrum.

5. A method according to claim 1, wherein the analyses comprises analysing each sample spectrum using a reference spectrum for each component to obtain the measured quantity and/or quality of the characteristic, and optionally, comprising selecting a reference spectrum for each component of the set of components, each reference spectrum selected from the plurality of component spectra for that component and differing from the component spectrum used to simulate the sample spectrum that is analysed using that reference spectrum and, further optionally, selecting different reference spectra for the analyses of different sample spectra.

6. A method according to claim 1, wherein the plurality of component spectra for each component is obtained by performing experiments in accordance with an experimental design, in which factors identified as influencing a spectral response the components are varied through a range of possibilities and, optionally, wherein the factors include one or more of the operator, time between preparation of a sample and measurement, instrument from which spectra are obtained, batch of the component(s) and batch of reagents.

7. A method according to claim 1, wherein the plurality of spectra obtained in step a) for each component are obtained with the component at the same reference concentration.

8. A method according to claim 1, wherein the sample spectra are simulated for different concentrations of the or each component in the corresponding potential sample.

9. A method according to claim 1, wherein the reference spectra and/or the component spectrum/spectra used to simulate the sample spectrum are randomly selected from an appropriate set of the component spectra.

10. A method according to claim 1, wherein the or each component in the corresponding potential sample and/or a concentration of the or each component in the corresponding potential sample is randomly selected based upon at least one probability distribution.

11. A method of designing a spectroscopy system comprising measuring a performance of the spectroscopy using the method according to claim 1 and selecting and/or modifying specifications of the system based upon the measurement of performance.

12. A spectroscopy system designed in accordance with the method of claim 11.

13. A data carrier having instructions thereon which, when executed by a processor, cause the processor to:
a) retrieve a plurality of component spectra for each component of a set of components that are to be identified by a spectroscopy system, the component spectra obtained for variations of at least one factor that affects the component spectrum,
b) simulate sample spectra, each sample spectrum simulated for a corresponding potential sample using at least one different component spectrum and/or a different amount of at least one of the component spectra to that used to simulate the other sample spectra;
c) analyse the sample spectra to obtain, for each sample spectrum, a measured quantity and/or quality of a characteristic for the corresponding potential sample, and
d) generate a measure of performance based upon the measured quantities and/or qualities.

14. Apparatus for measuring the performance of a spectroscopy system, the apparatus comprising:—
a processor arranged to:
a) retrieve a plurality of component spectra for each component of a set of components that are to be identified by a spectroscopy system, the component spectra obtained for variations of at least one factor that affects the component spectrum,
b) simulate sample spectra, each sample spectrum simulated for a corresponding potential sample using at least one different component spectrum and/or a different amount of at least one of the component spectra to that used to simulate the other sample spectra;
c) analyse the sample spectra to obtain, for each sample spectrum, a measured quantity and/or quality of a characteristic for the corresponding potential sample, and
d) generate a measure of performance based upon the measured quantities and/or qualities.

15. A method of measuring the performance of a spectroscopy system comprising
a) obtaining a plurality of component spectra for each component of a set of components that are to be identified by the system, the component spectra obtained for variations of at least one factor that affects the component spectrum,
b) simulating a sample spectrum for a potential sample using the component spectra;
c) analysing the sample spectrum multiple times using different sets of reference spectra selected from the plurality of component spectra to obtain a measured quantity and/or quality of a characteristic of the potential sample with each set of reference spectra, and
d) generating a measure of performance based upon the measured quantities and/or qualities.
